(19) United States
(12) Patent Application Publication
(10) Pub. No.: US 2021/0198982 A1
(43) Pub. Date: Jul. 1, 2021

(54) SEA WATER VACUUMING SYSTEM TO CONTAIN SPILL

(71) Applicant: Saudi Arabian Oil Company, Dhahran (SA)

(72) Inventors: Khaled ASFAHANI, Dhahran (SA); Ali QASEM, Dhahran (SA); Mansour AL-MANSOUR, Dhahran (US)

(73) Assignee: Saudi Arabian Oil Company, Dhahran (SA)

(21) Appl. No.: 17/133,150

(22) Filed: Dec. 23, 2020

Related U.S. Application Data
(60) Provisional application No. 62/953,806, filed on Dec. 26, 2019.

(51) Int. Cl. E21B 43/01; E02B 15/04; C02F 1/40; B01D 17/02

(52) U.S. Cl. CPC E21B 43/0122; E02B 15/046; C02F 2103/08; B01D 17/02; E02B 15/045; C02F 1/40

(57) ABSTRACT

Systems and methods for containing a subsea flow of hydrocarbons includes a water intake. The water intake is operable to be positioned downstream of the subsea flow of hydrocarbons. A receiving facility is located at a surface of a sea. A suction hose extends from the water intake to the receiving facility. A suction system is operable to reduce a fluid pressure within the water intake.

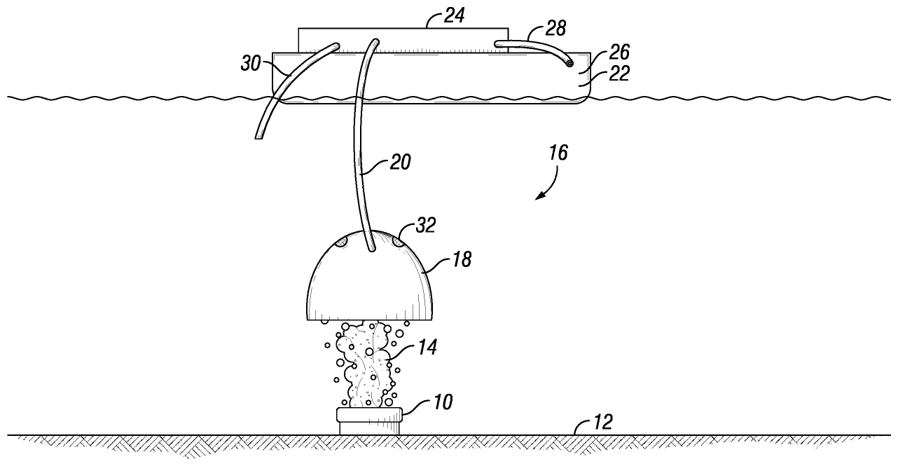

### CROSS REFERENCE TO RELATED APPLICATION

This application claims priority to and the benefit of co-pending U.S. Provisional Application Ser. No. 62/953,806, filed Dec. 26, 2019, titled “Sea Water Vacuuming System To Contain Spill,” the full disclosure of which is hereby incorporated herein by reference in its entirety for all purposes.

### BACKGROUND OF THE DISCLOSURE

### 1. Field of the Disclosure

The present technology relates to oil and gas production spills. In particular, the present technology relates to containing spills from subsea oil and gas wells.

### 2. Description of the Related Art

In every subsea hydrocarbon development operation there is some chance of a hydrocarbon spill. It is desirable to contain any subsea hydrocarbon spill as quickly as possible in order to mitigate damages caused by such spill. The longer the time period during which the hydrocarbon spill continues unaddressed, the more damage occurs to environment and the related eco-systems.

### SUMMARY OF THE DISCLOSURE

Embodiments of this disclosure provide systems and methods for containing a hydrocarbon spill for an unexpected spill, such as a spill due to a catastrophic event, unit a permanent solution for addressing the spill is found. Embodiments of this disclosure can mitigate and minimize any associated environmental risk by reducing the spill footprint within the marine environment.

In an embodiment of this disclosure, a system for containing a subsea flow of hydrocarbons includes a water intake. The water intake is operable to be positioned downstream of the subsea flow of hydrocarbons. A receiving facility is located at a surface of a sea. A suction hose extends from the water intake to the receiving facility. A suction system is operable to reduce a fluid pressure within the water intake.

In alternate embodiments, the water intake can have an open end facing towards the subsea flow of hydrocarbons and an opposite end that seals around the suction hose. The open end of the water intake can have a width of at least one meter. The open end of the water intake can alternately have a width of at least four meters. The water intake can have a generally dome shape.

In other alternate embodiments, the receiving facility can be a floating vessel. The receiving facility can include an oily water separator and a hydrocarbon storage tank. The receiving facility can have a separated water line extending from the oily water separator and towards the sea. The suction hose can be sized to transport 400 cubic meters of an oily water per hour to the receiving facility. The suction system can include a vacuum unit located at the receiving facility. The suction system can include a suction unit located at the water intake.

In another embodiment of this disclosure, a method for containing a subsea flow of hydrocarbons includes positioning a water intake downstream of the subsea flow of hydrocarbons. A suction hose extends from the water intake to a receiving facility, the receiving facility located at a surface of a sea. A suction system is operated to reduce a fluid pressure within the water intake, and draw the flow of hydrocarbons to the receiving facility.

In alternate embodiments, an open end of the water intake can be positioned to face towards the subsea flow of hydrocarbons and an opposite end of the water intake can seal around the suction hose. The hydrocarbons can be separated from a seawater with an oily water separator of the receiving facility. A separated hydrocarbon can be delivered to a hydrocarbon storage tank of the receiving facility. A separated water can be delivered through a separated water line extending from the oily water separator and towards the sea.

In other alternate embodiments, the suction hose can be sized to transport 400 cubic meters of an oily water per hour to the receiving facility. A vacuum unit of the suction system that is located at the receiving facility can be operated for drawing the flow of hydrocarbons to the receiving facility. A suction unit located at the water intake can be operated for drawing the flow of hydrocarbons to the receiving facility.

### BRIEF DESCRIPTION OF THE DRAWINGS

So that the manner in which the above-recited features, aspects and advantages of the disclosure, as well as others that will become apparent, are attained and can be understood in detail, a more particular description of the embodiments of the disclosure briefly summarized above may be had by reference to the embodiments thereof that are illustrated in the drawings that form a part of this specification. It is to be noted, however, that the appended drawings illustrate only certain embodiments of the disclosure and are, therefore, not to be considered limiting of the disclosure's scope, for the disclosure may admit to other equally effective embodiments.

The FIGURE is a schematic view of subsea hydrocarbon development with a sea water vacuuming system according to an embodiment of this disclosure.

### DETAILED DESCRIPTION

The Specification, which includes the Summary of Disclosure, Brief Description of the Drawings and the Detailed Description, and the appended Claims refer to particular features (including process or method steps) of the disclosure. Those of skill in the art understand that the disclosure includes all possible combinations and uses of particular features described in the Specification. Those of skill in the art understand that the disclosure is not limited to or by the description of embodiments given in the Specification. The inventive subject matter is not restricted except only in the spirit of the Specification and appended Claims.

Those of skill in the art also understand that the terminology used for describing particular embodiments does not limit the scope or breadth of the disclosure. In interpreting the Specification and appended Claims, all terms should be interpreted in the broadest possible manner consistent with the context of each term. All technical and scientific terms used in the Specification and appended Claims have the same meaning as commonly understood by one of ordinary skill in the art to which this disclosure relates unless defined otherwise.

As used in the Specification and appended Claims, the singular forms “a”, “an”, and “the” include plural references unless the context clearly indicates otherwise. As used, the words “comprise,” “has,” “includes”, and all other grammatical variations are each intended to have an open, non-limiting meaning that does not exclude additional elements, components or steps. Embodiments of the present disclosure may suitably “comprise”, “consist” or “consist essentially of” the limiting features disclosed, and may be practiced in the absence of a limiting feature not disclosed. For example, it can be recognized by those skilled in the art that certain steps can be combined into a single step.

Spatial terms describe the relative position of an object or a group of objects relative to another object or group of objects. The spatial relationships apply along vertical and horizontal axes. Orientation and relational words including “uphole” and “downhole”; “above” and “below” and other like terms are for descriptive convenience and are not limiting unless otherwise indicated.

Where the Specification or the appended Claims provide a range of values, it is understood that the interval encompasses each intervening value between the upper limit and the lower limit as well as the upper limit and the lower limit. The disclosure encompasses and bounds smaller ranges of the interval subject to any specific exclusion provided.

Where reference is made in the Specification and appended Claims to a method comprising two or more defined steps, the defined steps can be carried out in any order or simultaneously except where the context excludes that possibility.

Looking at the FIGURE, a subsea hydrocarbon development can include well 10. Well 10 can be located at sea floor 12. The subsea hydrocarbon development can produce oil, gas, or a mixture of oil and gas. There may be a time when the subsea hydrocarbon development experiences a leak or a spill. As an example, the subsea hydrocarbon development can experience a catastrophic event that leads to a spill of hydrocarbons. The spill can be, for example, hydrocarbon plume 14 that is released from well 10. Hydrocarbon plume 14 represents a flow of hydrocarbons into the sea from well 10.

In order to mitigate damages caused by hydrocarbon plume 14, sea water vacuuming system 16 can be used to collect the hydrocarbons that are spilling into the sea. Sea water vacuuming system 16 can include water intake 18. Water intake 18 can have a generally dome shape. Water intake 18 has an open end facing towards the subsea flow of hydrocarbons. Water intake 18 can also have an end that is opposite the open end that seals around suction hose 20.

The generally dome shape can have one of a variety of cross sectional shapes. As an example, water intake 18 can have a circular cross section such that water intake 18 has a generally frusto conical shape. Alternately, water intake 18 can have a square or rectangular cross section so that water intake 18 has a generally pyramidal shape. In alternate embodiments, water intake 18 can have a cross section with more than four sides so that water intake has a general umbrella shape.

Water intake 18 can be positioned downstream of the subsea flow of hydrocarbons so that hydrocarbon plume 14 travels into water intake 18. In the example embodiment of the FIGURE, because hydrocarbons are lighter than seawater, water intake 18 can be positioned axially above well 10. Water intake 18 can be positioned sufficiently close to hydrocarbon plume 14 so that water intake 18 can capture all of the flow of hydrocarbons before such hydrocarbons are dispersed and spread out within the sea.

In order to accommodate the full flow of hydrocarbons from hydrocarbon plume 14, the open end of water intake 18 can have a width of at least one meter. In alternate embodiments, the open end of water intake 18 can have a width of at least four meters.

Water intake 18 can be designed to be adjusted in different directions to accommodate a flow of hydrocarbons in various directions. Water intake 18 can maintain its position within the sea and can maintain its structural integrity against the pressure of the flow of hydrocarbons from hydrocarbon plume 14.

Suction hose 20 can be used to deliver the hydrocarbons from hydrocarbon plume 14, as well as sea water that also enters water intake 18, to receiving facility 22 in the form of an oily water. Suction hose 20 can have a combination of flexibility and rigidity required to maintain the performance characteristics required for delivering the fluids to receiving facility 22 while overcoming wave and current forces within the sea. Suction hose 20 can have sufficient strength to support water intake 18 within the sea. Suction hose 20 can further be designed to withstand the expected accumulation of the crude oil from blocking suction hose 20.

Suction hose 20 can have a sufficient inner diameter to accommodate a flow of hydrocarbons at a rate of at least 400 cubic meters per hour of oily water.

Receiving facility 22 can be located at a surface of the sea. Receiving facility 22 can be, for example, a floating vessel, such as a barge or a tanker. Receiving facility 22 collects the oily water that is transported through suction hose 20.

Receiving facility 22 can include oily water separator 24. The oily water that is transported through suction hose 20 is delivered directly to oily water separator 24. Oily water separator 24 can separate water from hydrocarbons to result in a separated water and a separated hydrocarbon. The separated hydrocarbon can be delivered to hydrocarbon storage tank 26. The separated hydrocarbon can be delivered from oily water separator 24 to hydrocarbon storage tank 26 through hydrocarbon hose 28. As an example, receiving facility 22 can be a supertanker with hydrocarbon storage tank 26 that can hold 1,500,000 barrels of separated hydrocarbon. In an example of operation, hydrocarbon storage tank 26 with a capacity of 1,500,000 barrels can accommodate a continuous spill for up to 25 days.

The separated water can be returned to the sea. Separated water line 30 can extend from oily water separator 24 towards the sea in order to deliver separated water from oily water separator 24 to the sea.

A suction system can be used to reduce a fluid pressure within water intake 18. The reduction in fluid pressure within water intake 18 can draw oily water from water intake 18 to receiving facility 22. The suction system can include a vacuum unit that is located at receiving facility 22. The vacuum unit can have the ability to suction up to 9600 cubic meters of oily water per day. One or more backup or standby vacuum units can be provided at receiving facility 22 in case of the failure of the primary vacuum unit. The suction system can further include suction unit 32 that is located at water intake 18.

In an example of operation in order to contain a subsea flow of hydrocarbons from a spill, water intake 18 can be positioned downstream of the subsea flow of hydrocarbons. Suction hose 20 can extend from water intake 18 to receiving facility 22 that is located at a surface of the sea. The open end of water intake 18 can be positioned to face towards the subsea flow of hydrocarbons. A suction system is operated to reduce a fluid pressure within water intake 18 to draw the flow of hydrocarbons to receiving facility 22.

The oily water can be separated with oily water separator 24 to form a separated hydrocarbon and a separated water. The separated hydrocarbon can be delivered to hydrocarbon storage tank 26 by way of hydrocarbon hose 28 and the separated water can be delivered back to the sea by way of separated water line 30.

Embodiments described herein, therefore, are well adapted to carry out the objects and attain the ends and advantages mentioned, as well as others inherent therein. While certain embodiments have been described for purposes of disclosure, numerous changes exist in the details of procedures for accomplishing the desired results. These and other similar modifications will readily suggest themselves to those skilled in the art, and are intended to be encompassed within the scope of the present disclosure disclosed herein and the scope of the appended claims.

What is claimed is:

1. A system for containing a subsea flow of hydrocarbons, the system including:
a water intake, the water intake operable to be positioned downstream of the subsea flow of hydrocarbons;
a receiving facility located at a surface of a sea;
a suction hose, the suction hose extending from the water intake to the receiving facility; and
a suction system operable to reduce a fluid pressure within the water intake.

2. The system of claim 1, where the water intake has an open end facing towards the subsea flow of hydrocarbons and an opposite end that seals around the suction hose.

3. The system of claim 2, where the open end of the water intake has a width of at least one meters.

4. The system of claim 2, where the open end of the water intake has a width of at least four meters.

5. The system of claim 1, where the water intake has a generally dome shape.

6. The system of claim 1, where the receiving facility is a floating vessel.

7. The system of claim 1, where the receiving facility includes an oily water separator and a hydrocarbon storage tank.

8. The system of claim 7, where the receiving facility has a separated water line extending from the oily water separator and towards the sea.

9. The system of claim 1, where the suction hose is sized to transport 400 cubic meters of an oily water per hour to the receiving facility.

10. The system of claim 1, where the suction system includes a vacuum unit located at the receiving facility.

11. The system of claim 1, where the suction system includes a suction unit located at the water intake.

12. A method for containing a subsea flow of hydrocarbons, the method including:
positioning a water intake downstream of the subsea flow of hydrocarbons;
extending a suction hose from the water intake to a receiving facility, the receiving facility located at a surface of a sea; and
operating a suction system to reduce a fluid pressure within the water intake, and drawing the subsea flow of hydrocarbons to the receiving facility.

13. The method of claim 12, where an open end of the water intake is positioned to face towards the subsea flow of hydrocarbons and an opposite end of the water intake seals around the suction hose.

14. The method of claim 12, further including separating a hydrocarbon from a seawater with an oily water separator of the receiving facility.

15. The method of claim 14, further including delivering a separated hydrocarbon to a hydrocarbon storage tank of the receiving facility.

16. The method of claim 14, further including delivering a separated water through a separated water line extending from the oily water separator and towards the sea.

17. The method of claim 12, where the suction hose is sized to transport 400 cubic meters of an oily water per hour to the receiving facility.

18. The method of claim 12, further including operating a vacuum unit of suction system located at the receiving facility for drawing the subsea flow of hydrocarbons to the receiving facility.

19. The method of claim 12, further including operating a suction unit located at the water intake for drawing the subsea flow of hydrocarbons to the receiving facility.
